(19) United States
(12) Patent Application Publication
(10) Pub. No.: US 2013/0040204 A1
(43) Pub. Date: Feb. 14, 2013

(54) Functional Nanocomposite Materials, Electrodes, and Energy Storage Systems

(71) Applicants: Jun Liu, Richland, WA (US); Yuliang Cao, (US); Xilin Chen, Richland, WA (US); Lifen Xiao, (US); Xiaolin Li, Richland, WA (US); Jiguang Zhang, Richland, WA (US); Gordon L. Graff, West Richland, WA (US); Zimin Nie, Richland, WA (US); Jie Xiao, Richland, WA (US)

(72) Inventors: Jun Liu, Richland, WA (US); Yuliang Cao, (US); Xilin Chen, Richland, WA (US); Lifen Xiao, (US); Xiaolin Li, Richland, WA (US); Jiguang Zhang, Richland, WA (US); Gordon L. Graff, West Richland, WA (US); Zimin Nie, Richland, WA (US); Jie Xiao, Richland, WA (US)

(73) Assignee: BATTELLE MEMORIAL INSTITUTE, Richland, WA (US)

(21) Appl. No.: 13/442,652

(22) Filed: Apr. 9, 2012

Related U.S. Application Data
(60) Provisional application No. 61/521,188, filed on Aug. 8, 2011.

(51) Int. Cl. H01M 4/62; H01M 4/38; B05D 5/12; H01B 1/00; B32B 5/16; B82Y 30/00

(52) U.S. Cl. 429/231.95; 428/403; 428/323; 428/328; 428/331; 428/327; 429/232; 427/58; 427/122; 427/123; 977/832; 977/773

(57) ABSTRACT

Particular functional nanocomposite materials can be employed as electrodes and/or as electrodes in energy storage systems to improve performance. In one example, the nanocomposite material is characterized by nanoparticles having a high-capacity active material, a core particle having a comminution material, and a thin electronically conductive coating having an electronically conductive material. The nanoparticles are fixed between the core particle and the conductive coating. The comminution material has a Mohs hardness that is greater than that of the active material. The core particle has a diameter less than 5000 nm and the nanoparticles have diameters less than 500 nm.

### PRIORITY

This invention claims priority from U.S. Provisional Patent Application No. 61/521,188, filed on Aug. 8, 2011 (Attorney Docket No 17156-E PROV), which is incorporated herein by reference.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### BACKGROUND

To meet the current and future energy storage requirements, much effort has been undertaken to explore novel reaction mechanisms and feasible materials for constructing safer and better energy storage systems. Among the various new materials being suggested for electric vehicle (EV) and hybrid electric vehicle (HEV) applications, electrochemical conversion materials have emerged as likely candidates for significant breakthroughs in storage capacity. For example, commercial lithium batteries primarily use graphite-based anodes, which have a specific capacity of 372 mAh g⁻¹ (LiC₆). Alternative anodes based on lithium-metal alloys have been actively pursued in recent years. Among these lithium-metal alloys, an alloy with silicon (Li₂₁Si₅) has the highest theoretical specific capacity (nearly 4200 mAh g⁻¹). However, very large volume changes (often more than 300 percent increase in volume) typically occur in the material when the lithium and silicon are alloyed. This large volume change can cause severe cracking and pulverization of an electrode, and lead to significant capacity loss.

In addition to Li—Si based alloys, a vast array of other lithium containing alloys (Li-A, where A represents Sn, Al, Bi, Ge, In, Sb, etc) and binary compounds (M-X, where M represent transition metal and X=F, O, S, and N) have been reported to exhibit superior reversible energy storage capacities that are several times higher than those observed by currently used cathode or anode materials. In particular, a large family of transition metal oxides, such as FeO, CoO, Cu₂O, etc., can exhibit, through the conversion reaction, a reversible capacity that is two to four times higher than presently commercialized graphite anodes. Based on this improved performance, these materials appear to have the potential for use as safer and higher-capacity materials that could replace carbonaceous anodes. However, many of these transition metal oxides or lithium containing alloys, like Li—Si alloys, exhibit a large volume change during charge/discharge processes. The volumetric change in these materials can result in severe cracking and pulverization of the electrode, and lead to significant capacity loss. These materials may also exhibit undesirable capacity fading and low initial Coulombic efficiency from undesirable, often irreversible, conversion reactions. Therefore, there is an urgent need for an electrode material with high capacity and good reversibility that can be synthesized in a cost effective method.

### SUMMARY

This document describes a functional nanocomposite material, an electrode comprising the nanocomposite material, and energy storage systems having such electrodes, as well as methods for making these functional nanocomposite materials. The nanocomposite material is characterized by nanoparticles comprising an active material, a core particle comprising a comminution material, and a thin electronically conductive coating comprising an electronically conductive material. The nanoparticles are fixed between the core particle and the conductive coating. The comminution material has a Mohs hardness that is greater than that of the active material. In one embodiment, the ratio of the core particle average diameter to the nanoparticle average diameter is between 2 and 50. In another embodiment, the core particle has a diameter less than 5000 nm and the nanoparticles have diameters less than 500 nm.

The functional nanocomposite material can be arranged as an electrode. One example includes, but is not limited to, mixing the nanocomposite material with a binder and forming the mixture into an electrode.

As used herein, an active material can refer to a material exhibiting performance characteristics that are better than those of traditional electrode materials. Examples of performance characteristics include, but are not limited to, capacity, cyclability, safety, high temperature and low temperature stability, and power rate. For example, if the nanocomposite material were arranged as an anode in an energy storage system, a suitable active material might have a capacity greater than that of graphite (372 mAh·g⁻¹). Often times, suitable active materials exhibit large volume expansion during physical, chemical, or electrochemical operation. The volume expansion can be caused by electrochemical reaction, chemical reaction, mechanical force, electromagnetic force, temperature, and/or humidity variation during operation as an electrode in an energy storage system.

In some embodiments, the active material of the nanoparticle can comprise tin and/or tin oxide, silicon and/or silicon oxide, germanium and/or germanium oxide, aluminium and/or aluminium oxide, or indium and/or indium oxide. In a particular embodiment, a nanocomposite material having nanoparticles comprising tin and/or tin oxide as the active material can have a reversible capacity of at least 400 mAh·g⁻¹ based on whole electrode weight when operated over 100 cycles. In an embodiment wherein the nanoparticles comprises silicon and/or silicon oxide, the reversible capacity can be at least 550 mAh·g⁻¹ based on whole electrode weight over 100 cycles. In preferred embodiments, the nanoparticles have diameters that are less than or equal to 50 nm.

In some embodiments, the comminution material is electrically conductive. For example, the comminution material can have a conductivity that is greater than 1 S/m. Particular examples of comminution materials (some of which are conductive) can include, but are not limited to boron carbide, tungsten carbide, titanium carbide, silicon carbide, and combinations thereof. The core particle, in some embodiments, is less than or equal to 1000 nm in diameter.

In some embodiments the conductive material comprises a carbonaceous material. Examples of carbonaceous materials can include, but are not limited to, graphene, few-layer graphene, graphite, ketjenblack, carbon black, Super P carbon black, carbon fibers, carbon whiskers, soft carbon, other carbonaceous material, and combinations thereof. Alternatively, the conductive material can comprise a conductive polymer. In still another embodiment, the conductive material can comprise a powder having metal particles. Preferably, the conductive coating is less than or equal to 50 nm thick.

The overall composition of the nanocomposite material can comprise 10-90 wt % active material, 5-85 wt % comminution material, and 5-85 wt % conductive material. The weight ratio of active material to the comminution material and to the conductive material can range from 18:1:1 to 2:17:1 or 2:1:17, respectively. Referring to these three weight ratios (18:1:1, 2:17:1, or 2:1:17), since there are three components (active, comminution, and conductive materials), the latter two compositions (2:17:1 and 2:1:17) have relatively small amounts of active material. Preferred embodiments have compositions in which the active material in the ternary composite is approximately 40 wt %. Furthermore, in preferred embodiments the comminution material and the conductive material have a weight ratio that is approximately 1:1. In one example, the weight ratio is 4:3:3, respectively.

One embodiment of an electrode can comprise a nanocomposite material characterized by nanoparticles comprising an active material, a core particle comprising a comminution material having an electrical conductivity greater than 1 S/m, and a thin electronically conductive coating comprising a carbon material. The nanoparticles are fixed between the core particle and the conductive coating, wherein the comminution material has a Mohs hardness greater than that of the active material. The core particles have an average diameter less than 1000 nm, and the nanoparticles have average diameters less than 200 nm. The electrode, when operated in a cell, has a capacity greater than 400 mAh·g⁻¹ based on whole electrode weight after 100 cycles. Preferably, the capacity is greater than 550 mAh·g⁻¹ based on whole electrode weight after 100 cycles.

In one embodiment of an energy storage device having a cathode and an anode, the anode comprises a nanocomposite material. The nanocomposite material is characterized by nanoparticles comprising an active material, a core particle comprising a comminution material, and a thin electronically conductive coating comprising an electronically conductive material. The nanoparticles are fixed between the core particle and the conductive coating, wherein the comminution material has a Mohs hardness greater than that of the active material. The core particle has a diameter less than 5000 nm, and the nanoparticles have diameters less than 500 nm. In some instances, the cathode can comprise lithium, lithium intercalation materials, lithium conversion materials, or combinations thereof.

One method of making the nanocomposite material comprises comminuting a first mixture comprising an active material and a comminution material until particles of the active material are less than 500 nm in average diameter and particles of the comminution material are less than 5000 nm in average diameter. The comminution material has a Mohs hardness greater than the active material. Particles of the active material can become fixed on the particles of the comminution material while performing said comminuting step, thereby yielding an intermediate nanocomposite. Mixing an amount of an electronically conductive material with the first mixture can result in coating the intermediate nanocomposite with the electronically conductive material to yield the final nanocomposite material. In some instances, the mixing step can also involve additional comminution.

In various embodiments, the first mixture can comprise 10-95 wt % active material. In other embodiments, the first mixture can comprise 5-90 wt % comminution material. In still other embodiments, the amount of the electronically conductive material is 5-85 wt % of the conductive material and first mixture total weight.

In some embodiments, the comminuting can proceed until the particles of the active material are less than 200 nm in diameter and particles of the comminution material are less than 2000 nm in diameter. In other embodiments, comminuting proceeds until the particles of the active material are less than 100 nm in diameter and particles of the comminution material are less than 1000 nm in diameter. One example of comminuting includes, but is not limited to ball milling.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The summary is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 includes X-ray diffraction (XRD) patterns of a nanocomposite material according to embodiments of the present invention.

FIG. 2a-2e includes transmission electron microscope (TEM) micrographs of a nanocomposite material according to embodiments of the present invention.

FIG. 2d is an illustration depicting the formation and structure of a nanocomposite material according to embodiments of the present invention.

FIG. 3 includes graphs of capacity as a function of cycle number for nanocomposite materials according to embodiments of the present invention.

FIG. 4a includes cyclic voltammetry curves of a nanocomposite material according to embodiments of the present invention.

FIG. 4b-d include graphs illustrating the electrochemical performance of nanocomposite materials described herein and applied as anodes.

FIG. 5a includes an X-ray photoelectron spectroscopy (XPS) spectrum acquired from nanocomposite materials described herein.

FIG. 5b is a TEM micrograph of a nanocomposite material described herein.

FIGS. 6a-c include diagrams and TEM micrographs depicting the formation and structure of a nanocomposite material described elsewhere herein.

FIG. 7a includes XRD patterns of various nanocomposite materials described elsewhere herein.

FIG. 7b-d include CV data for various nanocomposite materials described elsewhere herein.

FIG. 8 includes graphs of discharge capacity as a function of cycle demonstrating the stability of electrodes according to embodiments of the present invention.

FIG. 9 includes discharge-charge profiles, long-term stability and rate performance data for an electrode according to embodiments of the present invention.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In one example, a nanocomposite material was synthesized and characterized for use as an electrode in an energy storage system. The nanocomposite of the instant example comprised SnO₂ as the active material, SiC as the comminution material, and graphite (G) as the conductive material. SnO₂ (99.5% purity, ˜200 mesh National medicine Co., Ltd, China Shanghai, hereafter called m-SnO₂), nano-SnO₂ (99.9% purity, ˜40 nm Alfa Aesar, hereafter called n-SnO₂), sphere-like SiC (99.5% purity, ten to a few hundred nanometers in diameter), and graphite (99% purity) were used as received. The SnO₂—SiC/G nanocomposites (SiC: SnO₂: C=20:70:10 wt %) were prepared by high-energy ball milling of the mixture of SiC and m-SnO₂ powders (8000M Mixer/Mill, SPEX, USA) for 20 h at 1725 rpm and then by ball milling the SnO₂—SiC composites with graphite by a planetary mill (QM-1SP04, Nanjing, China) at a rotation speed of 240 rpm for 6 h. The weight ratio of milling balls to the powder materials was maintained at 20 to 1.

The crystalline structure of the as-prepared nanocomposites was characterized by XRD on a Shimadzu x-ray diffractometer using Cu Ka radiation. XRD data were obtained at 2θ=10-80°, with a step size of 0.02°. From the XRD data, the lattice parameters were calculated based on the Scherrer equation (d=0.9λ/(β cos θ). XPS measurements were carried out with a Kratos XSAM800 Ultra spectrometer. The morphologies of the composite particles were characterized by TEM (JEOL 2010).

The electrochemical evaluation of the prepared functional nanocomposite materials were carried out with a half-cell configuration using 2016-type coin cells. Stainless steel was used as the current collector, and Li foil was used as the counter and reference electrode. The electrolyte was 1-M LiPF₆ dissolved in a mixture of ethylene carbonate (EC), dimethyl carbonate (DMC), and ethylene methyl carbonate (EMC) (1:1:1 by weight, Shinestar Battery Materials Company Ltd, China), and the separator was a microporous membrane (Celgard® 2400). The composite anode was prepared by mixing 70 wt % composite powder, 22 wt % acetylene black, 4 wt % carboxymethyl cellulose (CMC) and 4 wt % styrene butadiene rubber (SBR), and dissolving the electrode mixture into distilled water to form a slurry. Then, the electrode slurry was coated on a nickel foam, pressed, and dried at 80° C. for 10 hours under vacuum. The cells were assembled in an argon-filled glove box and galvanostatically charged and discharged using a battery tester (Land CT2001A, Wuhan, China) at room temperature. The electrochemical capacity was calculated based on the SnO₂ mass and on the whole electrode weight (e.g., active material, comminution material, conductive material and binder). CV measurements also were carried out with the three-electrode cell at a scan rate of 0.1 mV s⁻¹.

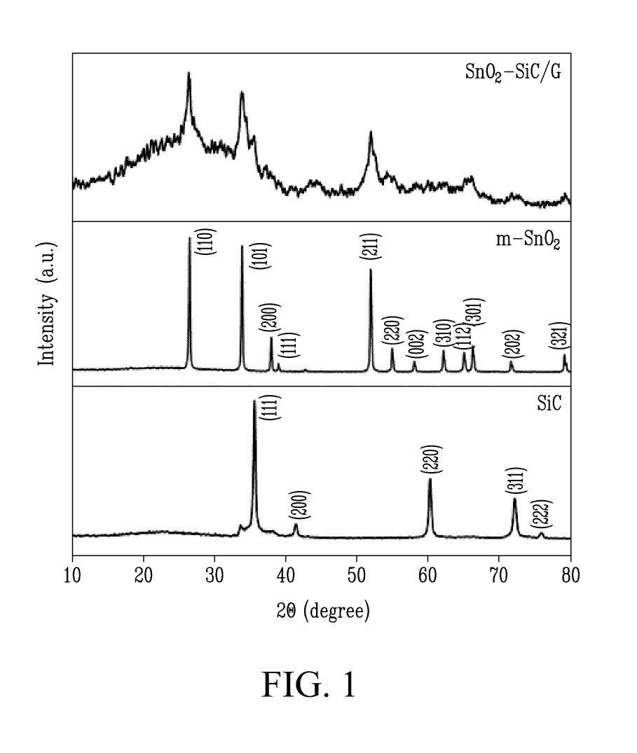

The crystalline structures of the SnO₂—SiC/G nanocomposite materials were characterized using x-ray powder diffraction (XRD). The diffraction peaks of SnO₂ in the nanocomposite materials appeared much weaker and broader compared to the XRD patterns of the pure m-SnO₂ sample shown in FIG. 1, implying a significant decrease in size and crystalline correlation length through ball milling. All peaks in the XRD pattern of the SnO₂—SiC/G nanocomposite material can be indexed to tetragonal SnO₂ (International Center for Diffraction Data [JCPDS] No. 41-1445, space group: P4₂/mnm, 136) and cubic SiC (JCPDS No. 75-0254, space group: F 4̅ 4̅ 3m, 186). The location of all the diffraction peaks and their widths are consistent with nanocrystalline SnO₂. Using the Scherrer equation (d=0.9λ/(β cos θ), the average crystalline correlation length of the as-synthesized SnO₂ nanocrystals in the nanocomposite material was calculated to be about ˜7 nm from 2θ and λ values of the SnO₂ (110) peak. These values were obtained by Lorentzian fitting of the XRD pattern. These results indicate that ball milling using rigid SiC can reduce the bulk SnO₂ grains to nanometer-sized particles.

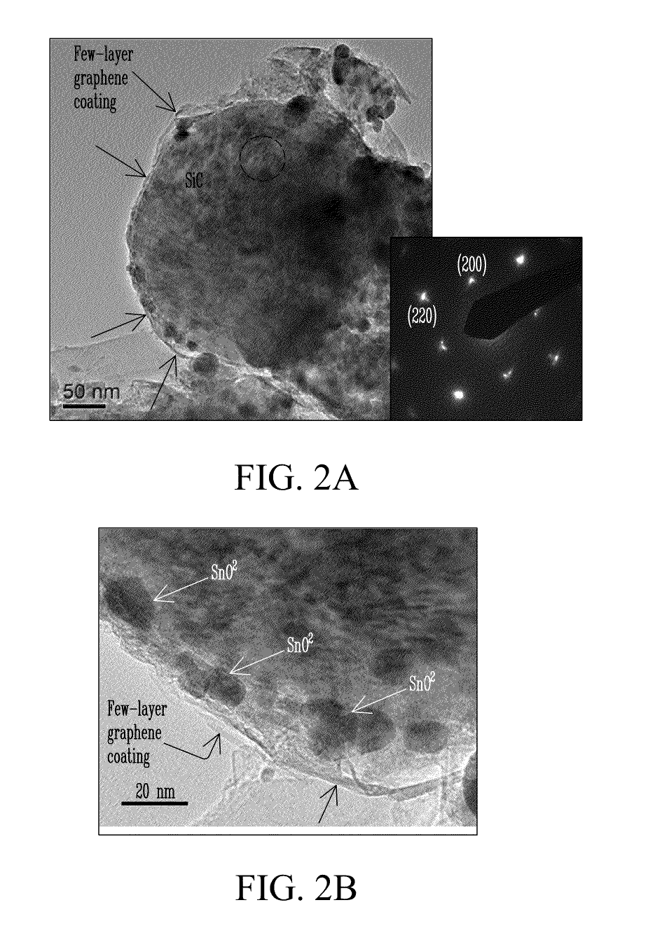

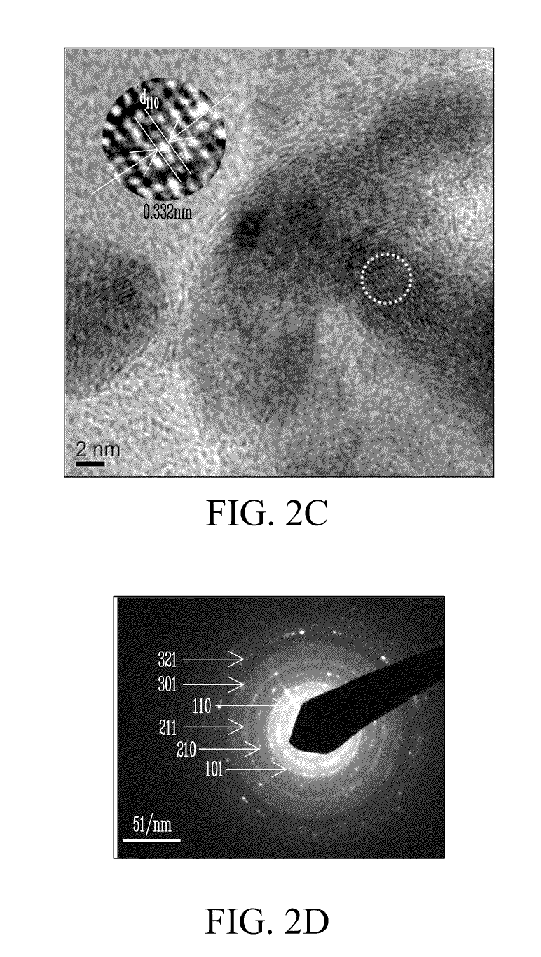

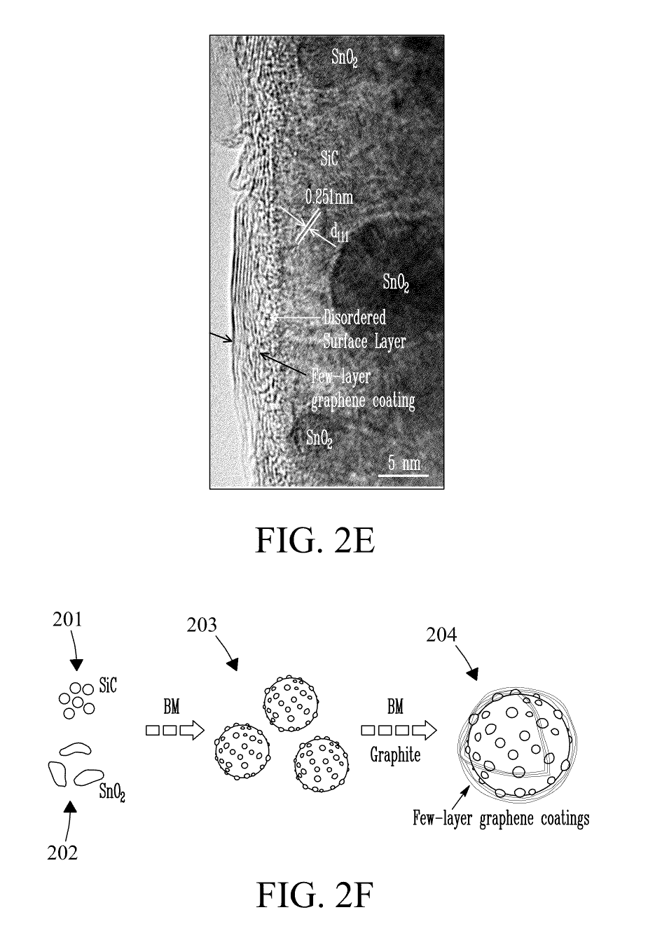

The morphology of the as-prepared nanocomposite was studied using transmission electron microscopy (TEM) (FIG. 2a-e). The SnO₂ nanoparticles shown in FIG. 2a were well dispersed on the spherical SiC substrate and contacted by a thin carbon layer (see the white arrows in the figure). The corresponding selected-area electron diffraction (SAED) pattern (see inset in FIG. 2a) recorded from the region marked by the dotted red circle in FIG. 2a shows well-resolved individual reflections, which indicates that the SiC particle is a single crystal with a cubic phase. The electron beam was incident along the [001] direction of the SiC lattice. The magnified TEM image (see FIG. 2b) shows clearly that the island-like SnO₂ nanoparticles, which are about 10 nm in size, are dispersed on the surface of the SiC particle. The corresponding ring-like SAED patterns (see FIG. 2d) from the inside to the outside can be indexed to the (110), (101), (210), (211), (301), and (321) planes of rutile SnO₂, respectively. The high-resolution TEM image shown in FIG. 2c shows that lattice fringes with a basal distance of 3.32 Å can be observed from the locally magnified image of the SnO₂ nanoparticles (the upper left inset of FIG. 2c), which is consistent with the (110) lattice spacing of tetragonal SnO₂ (JCPDS No. 41-1445, space group: P4₂/mnm, 136). These indexed patterns are consistent with the XRD results described earlier. In addition, a high-resolution TEM image of the edge of the particle (FIG. 2e) shows an outer carbon coating layer of graphene stacks (4 to 10 layers). In this example, the entire SiC core with the supported SnO₂ nanoparticle is coated with rather uniform layers of graphene stacks. The distance between the graphene stacks is about 0.35 nm, which is slightly larger than the basal distance of graphite, suggesting that the graphite particles are broken down and the graphite crystalline structure becomes more disordered during mechanical peening. Based on the results of the XRD and TEM studies, the carbon coating on the surface can be considered to be a few-layer graphene coating.

SiC particles can play a role as a comminution material in obtaining the structure shown in the TEM images. The SiC can be introduced into the ball-milling process as an abrasive for its high rigidity (9.3 on the Mohs' scale of hardness) to reduce bulk SnO₂ grains to nanometer-sized particles and to function as a support, with its abundant surface area (90 m²/g), for the SnO₂ nanoparticles. The illustration in FIG. 2f depicts in one sense the formation of a SnO₂—SiC/G nanocomposite. By ball milling, SiC 201 and SnO₂ 202 powders, bulk SnO₂ particles 201 are reduced to nanosized particles and dispersed and attached uniformly on the surface of SiC particles to produce a primary SnO₂—SiC nanocomposite material 203. When the graphite is ball-milled with SiC and/or the primary SnO₂—SiC nanocomposite material 203, the particle sizes decrease and the carbon layers are continuously peeled from the particles. The SnO₂—SiC primary nanocomposite particles were coated with few-layer graphene to form a SnO₂—SiC/G core-shell nanostructure 204. In this structure, the SiC substrate can provide a robust framework that buffers the volumetric changes of the lithiation/delithiation process, and the presence of the graphene stacks can provide good conductivity and also prevent the agglomeration of the individual SnO₂ nanoparticles.

The properties of SnO₂—SiC/G material were studied using a voltage window of 1.5 to 0.01 V for the following alloying reaction.

SnO₂+4Li⁺+4e⁻→Sn+2Li₂O (1)

Sn+xLi⁺+xe⁻⇄LiₓSn (0<x<4.4) (2)

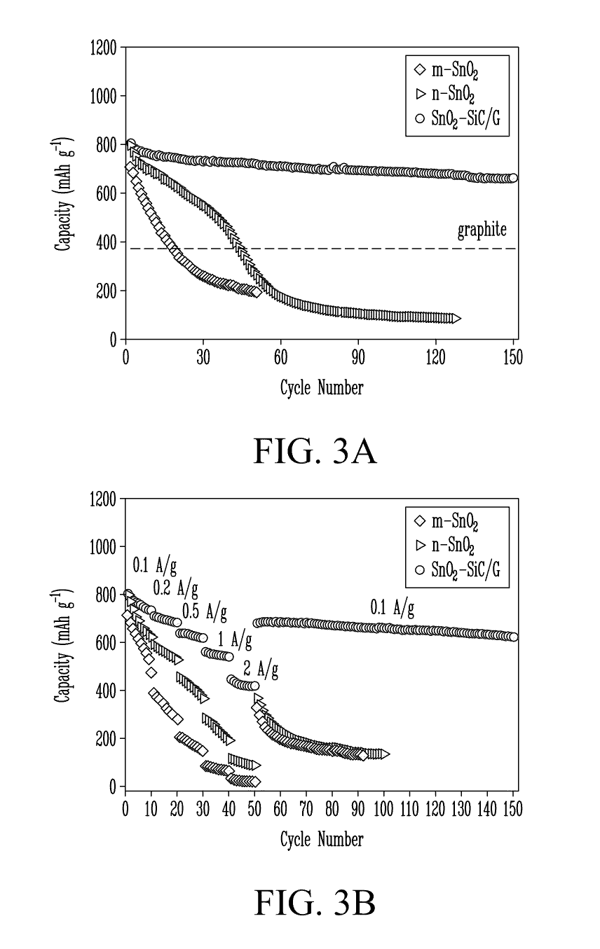

FIG. 3a shows the cycling performance of SnO₂—SiC/G at a constant current density of 0.1 A·g⁻¹. The initial charge (i.e., Li extraction) capacity in the potential range between 1.5 and 0.01 V obtained is 810 mAh·g⁻¹ (based on the SnO₂ mass calculated: C_{SnO2}=[Cₜₒₜₐₗ₁−0.1*C_{graphite}]/0.7, assuming that graphite has a theoretical capacity [C_{graphite}] of 372 mAh·g⁻¹), which corresponds to a fully reversible alloying/dealloying reaction. A high reversible capacity of 670 mAh·g⁻¹ can be retained over 150 cycles, which corresponds to 83% capacity retention. For comparison, the cycling performance of the n-SnO₂ and m-SnO₂ electrodes is provided in FIG. 3a. Their capacities fade dramatically to a value lower than 300 mAh·g⁻¹ in less than 50 cycles. To fully estimate the electrochemical performance of the SnO₂—SiC/G core-shell structure at this smaller potential range, the cycling data at various charge-discharge rates are shown in FIG. 3b. The nanocomposites retain a capacity of 425 mAh·g⁻¹ at a current density of 2 A·g⁻¹, thus exhibiting an excellent rate capability.

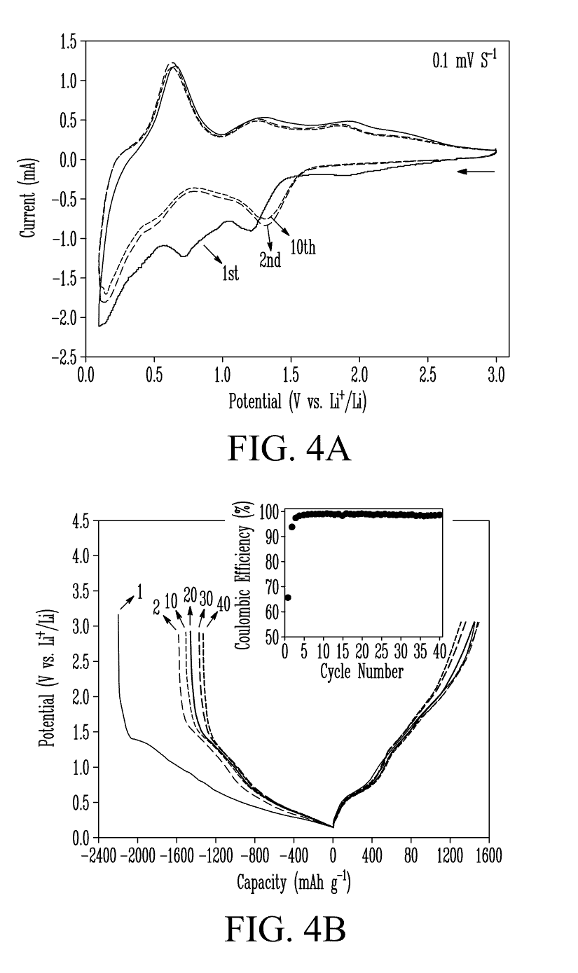

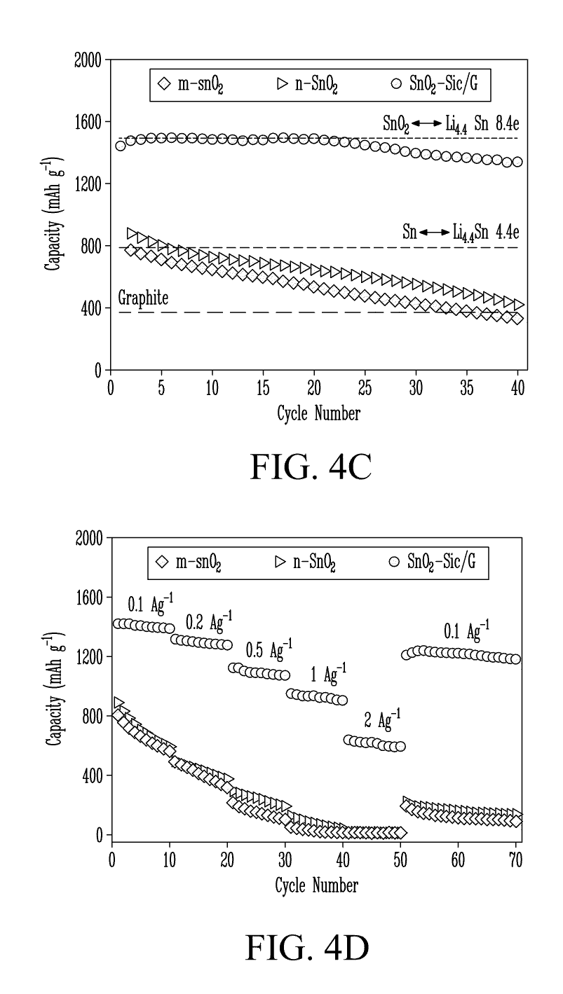

The effect on the Li-storage properties of the as-prepared SnO₂—SiC/G nanocomposite electrode, including the alloying and conversion reactions, can be demonstrated by the following series of electrochemical measurements performed at the wider voltage window of 3.0 to 0.01 V. FIG. 4a shows typical cyclic voltammetry (CV) curves of the SnO₂—SiC/G nanocomposite materials at a slow scan rate of 0.1 mV s⁻¹ in the range of 3.0 to 0 V. In the first negative scan, there are two broad cathodic peaks at 2.5˜1.5 V and 1.0˜0.6 V, respectively. These peaks disappeared at the second scan, and thereafter, in agreement with decomposition of the solvent on the surface of SnO₂ and the newly formed metallic Sn, formed the solid electrolyte interphase (SEI). From the scans shown in FIGS. 4b-d, three characteristic pairs of redox peaks are clearly observed at the potential of (0.05 V, 0.60 V), (0.5 V, 1.2 V) and (1.25 V, 1.8 V). The first pair is ascribed to the reversible alloying and dealloying reaction given by Equation 2, while the other two pairs are related to the conversion reaction depicted in Equation 1. There is almost no noticeable change of current or potential observed for the three pairs of redox peaks in the subsequent cycling compared to that of pure SnO₂ electrodes (data not shown), indicating that the conversion reaction of the SnO₂—SiC/ seems to be as reversible as the alloying and dealloying reactions.

The lithium lithiation/delithiation profiles of the SnO₂—SiC/G electrode at a current density of 0.1 A·g⁻¹ in a voltage range of 3.0 to 0.01 V are shown in FIG. 4b. The SnO₂—SiC/G structure delivered a discharge (Li-insertion) capacity of 2198 mAh·g⁻¹ for the first cycle, which is much more than the theoretical value (i.e., 1494 mAh·g⁻¹, 8.4 e⁻ for SnO₂). These results demonstrate that in some embodiments, the conversion reaction for the SnO₂—SiC/G electrode is indeed reversible. The initial capacity loss of the SnO₂—SiC/G electrode, most likely arising from the formation of an SEI film and electrochemical decomposition of the solvent, was 34% for the first cycle. Nevertheless, the coulombic efficiency of the electrode increased to 98% at the fourth cycle and remained stable for subsequent cycles (inset in FIG. 4b). In particular, the SnO₂—SiC/G electrode delivers a high capacity of 1351 mAh·g⁻¹ (93% of the initial reversible capacity) up to 40 cycles, which is much higher than the pure SnO₂ electrodes used as controls (FIG. 4c).

FIG. 4d shows the cycling performance and rate capability comparison of the SnO₂—SiC/G nanocomposite material and the pure SnO₂ electrodes. The cells were charged and discharged between 3.0 and 0.01 V under current densities ranging from 0.1 A·g⁻¹ to 2 A·g⁻¹. As shown in FIG. 4d, the composite retains a high capacity of ˜656 mAh·g⁻¹ even at a current density of 2 A·g⁻¹. In comparison, the pure SnO₂ electrodes (m-SnO₂ and n-SnO₂) produced only a reversible capacity of less than 100 mAh·g⁻¹ at a current density of 2 A·g⁻¹, exhibiting a rather poor rate capability. When SnO₂—SiC/G was cycled at a current density of 0.1 A·g⁻¹ for the first five cycles and 0.5 A·g⁻¹ for the following cycles, the SnO₂—SiC/G electrode delivered a reversible capacity of 1251 mAh·g⁻¹ at the sixth cycle, and still retained 85% of its initial capacity for up to 70 cycles. Compared to the SnO₂—SiC/G samples, pure SnO₂ with different particles sizes showed rather poor cycling performance, retaining less than 20% of their initial capacities (FIG. 4d).

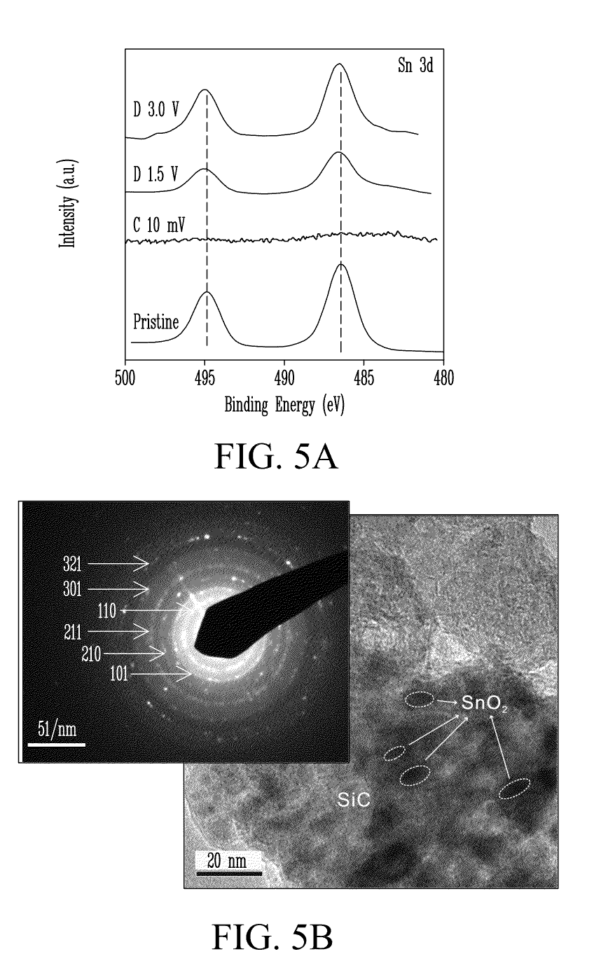

X-ray photoelectron spectroscopy (XPS) and TEM analyses were used to characterize the structural and morphological changes of the electrode. FIG. 5a shows the XPS spectrum for the Sn 3d levels at different depths of charge and discharge for the SnO₂—SiC/G electrode. As seen in the figure, after a first charge at 0.01 V, the two peaks at ˜486.9 and ˜495.0 eV that were assigned to Sn 3d_{5/2} and 3d_{3/2}, respectively. In the XPS spectrum of the pristine SnO₂—SiC/G electrode, disappeared as the SnO₂ was reduced. The XPS signal of the Sn 3d₃₁₂ level was not detected for the Li_{4.4}Sn phase, which might be attributed to the increase in the SEI film thickness and the embedded Li_{4.4}Sn in the amorphous Li₂O matrix. However, the characteristic XPS peaks for SnO₂ reappeared after the first discharge to 1.5 and 3.0 V, confirming that the matrix Li₂O can react with newly formed metallic Sn to yield SnO₂ when discharged to less than 1.5 V.

The reversible conversion to SnO₂ also is supported by the TEM analysis of the cycled SnO₂—SiC/G sample. As shown in FIG. 5b, the overall morphology of the nanocomposite is maintained, including the thin graphite shell on the surface. After 70 cycles, the SnO₂ nanoparticles remain separated on the SiC substrate and are surrounded by the carbon shell without any aggregation when charged to 3.0 V. The corresponding SAED pattern (inset in FIG. 5b) confirms a crystalline rutile SnO₂ structure, indicating that Sn and Li₂O could reversibly react to form SnO₂ after the charging process. This is in agreement with the XPS results.

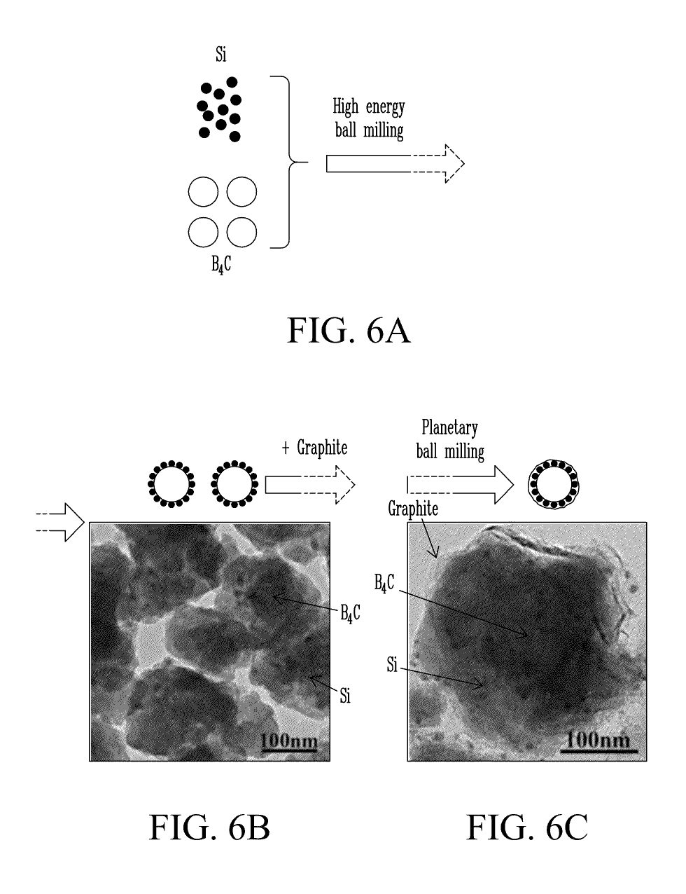

In another example, a nanocomposite material was synthesized comprising silicon as the active material, B₄C as the comminution material, and micro-sized graphite as the conductive material. As shown in FIG. 6, a B₄C/Si/graphite nanocomposite 604 was prepared by ball milling (BM) a mixture of Si 601 and B₄C 602 powders in a high energy ball mill (8000M Mixer/Mill, SPEX, US) and then by ball milling the Si/B₄C intermediate composite 603 with graphite in a planetary mill (Retsch, PM200) at 400 rpm. The weight ratio of S₁, B₄C and graphite, is 4:1:5 (labeled as SBG415), 4:3:3 (labeled as SBG433), and 4:5:1 (labeled as SBG451). In one experiment, the time for both high energy ball milling and planetary ball milling was 8 hours; in another experiment, the time for both high energy ball milling and planetary ball milling was 4 hours; in yet another experiment, the time for both high energy ball milling and planetary ball milling was 12 hours. The Si:B₄C:graphite ratio was 4:3:3 for the three experiments in which the milling time was varied. While the illustration in FIG. 6 depicts the particles as spheres, in practice, the particles can have any shape as shown in the micrographs 605 and 606. In such instances, the largest diameters across the particles can be measured and averaged to estimate size.

The Si:B₄C:graphite nanocomposites were characterized by XRD (Philips X'Pert X-ray diffractometer), TEM (JEOL-2010) and BET (QUANTACHROME AUTOSORB 6-B). An electrode sheet was prepared by casting a slurry of the Si:B₄C:graphite nanocomposite, conductive carbon black (SUPER P®, from TIMCAL), and carboxymethyl cellulose sodium salt (Na-CMC, Kynar HSV900,®, from Arkema Inc.) solution (2.5 wt. %) in distilled water onto copper foil. The weight ratio of Si:B₄C:graphite, SP, and CMC was 70:10:20, respectively. After water was evaporated, the electrode sheet was die cut into disks with a diameter of approximately 1.27 cm and dried overnight under vacuum at 110° C.

Half cells were assembled in an argon-filled glove box using Li metal for the counter electrode, CELGARD K1640® as a polyethylene-based electrolyte separator, and 1-M LiPF₆ in EC/DMC (1:2 ratio in volume) as the electrolyte with 10 wt % FEC additive. The electrochemical performance of the coin cells was measured at room temperature using an ARBIN® BT-2000 battery tester. The cells were cycled between 0.02 and 1.5 V. Cyclic voltammetry (CV) scans were conducted on a CHI 1000A® impedance analyzer at a scan rate of 0.05 mVs⁻¹ measured between 0 and 1.5 V using a two-electrode cell configuration.

The morphology of the as-prepared intermediate and final products were studied by transmission electron microscopy (TEM). FIGS. 6b and 6c shows the TEM images of the intermediate product (Si/B₄C) 605 and final product (Si/B₄C/graphite) 606 of SBG433, respectively. FIG. 6b shows that the size of the silicon particles has been significantly reduced from 1-5 μm to less than 10 nm after high energy ball-milling. The TEM image also shows that the particle size of the conductive comminution material B₄C is reduced from 1-7 μm to 100-300 nm during the high energy ball-milling. The in-situ generated nano-sized silicon particles attach on the B₄C particles forming the silicon coated B₄C core-shell structure. FIG. 6c shows core-shell structured B₄C/Si composite is substantially covered by another shell, a thin layer of graphite, to form a substantially three-layer core-shell-shell structure.

The crystalline structures of the precursors and Si:B₄C:graphite composites with different compositions were characterized by X-ray diffraction (not shown). Regarding the SBG415, SBG433 and SBG451 samples, the intensity of the graphite peaks decreases when the graphite content decreases from 50% to 10% while the peak intensity of B₄C increases when the B₄C content increases from 10% to 50%. The peak intensity of the silicon increases even though the silicon ratio doesn't change. The increase of the silicon peak intensity is likely due to the decreasing thickness of graphite in the series. This phenomenon also corroborates the core-shell-shell structure in which the silicon (i.e., active material) shell is mostly, if not fully, covered by the graphite (i.e., conductive material) shell. The clear and sharp silicon characteristic peaks indicate some of the silicon keeps its crystalline structure after the comminution (e.g., ball-milling) processes. The characteristic peaks for silicon become broader after ball-milling likely due to the significant particle size decrease and the silicon becoming more amorphous. However, there is no visible change for the characteristic peaks for B₄C particle even though a decrease in size has been observed in the TEM images.

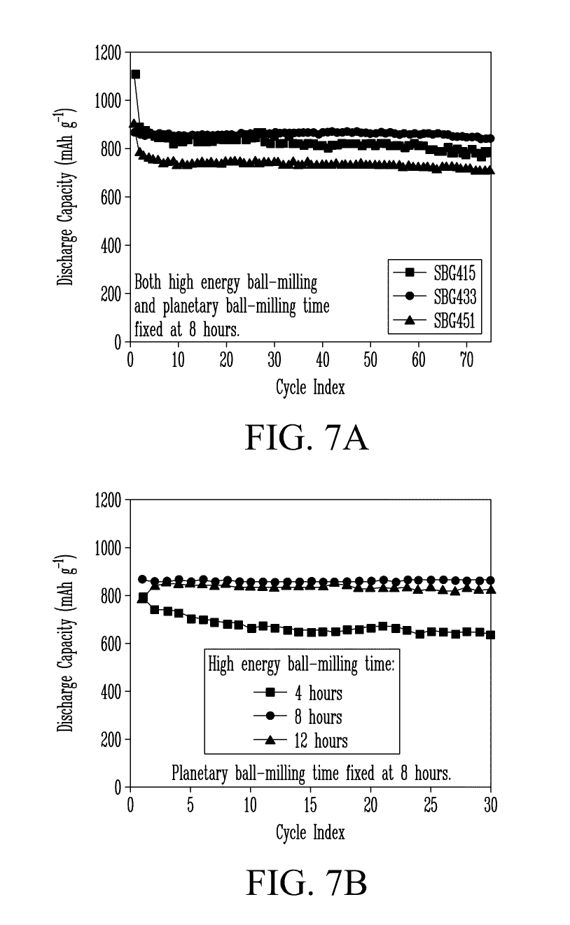

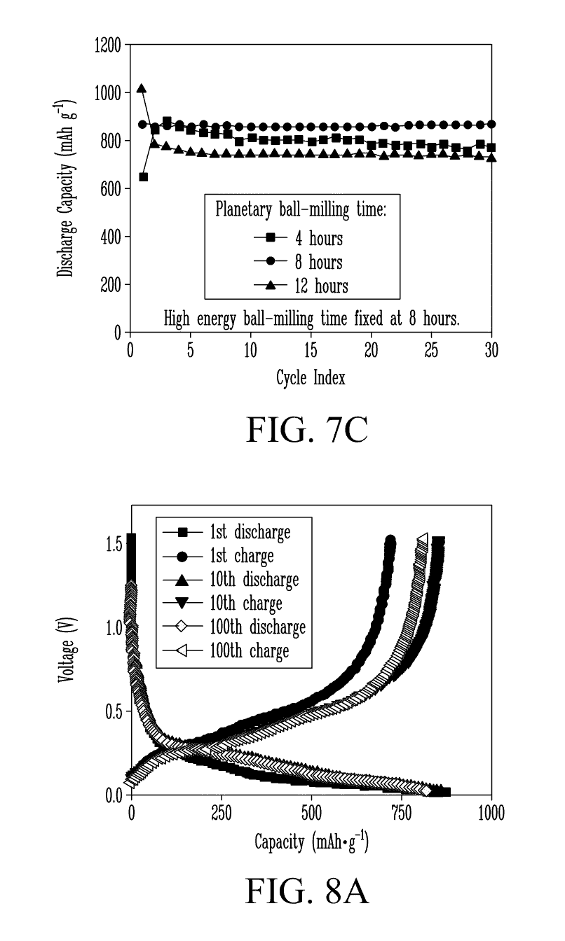

The long-term stabilities of SBG415, SBG433 and SBG451 under similar ball milling time (8 hours) were compared in FIG. 7a. Generally, all three of the samples show good stability and a high capacity around 800 mAhg⁻¹ based on whole electrode weight including binder and conductive carbon. After 75 cycles, the capacity retention is 88.0% for SBG415, 98.3% for SBG433 and 90.0% for SBG451. Since there is irreversible capacity in the first cycle likely due to the formation of a solid electrolyte interphase (SEI) film, the discharge capacity in the second cycle is used for the capacity retention calculation. Among these three samples, SBG433 shows the greatest stability and the highest capacity. As described in the experimental section, the amount of the boron carbide component in the composites increases in the order of SBG415<SBG433<SBG451. More boron carbide can mean a relatively more conductive rigid skeleton, which can result in more composite particles and/or larger sized nanocomposite particles. However, the amount of silicon was substantially the same in the example composite above. Thus, the thickness of silicon shell appears to increase in the order of SBG415>SBG433>SBG451. The Si:B₄C:graphite particle with thinner silicon layers would experience smaller volume change during lithiation and delithiation and can have smaller impact to the electrode structure. The soft graphite used as the conductive material can alleviate the stress generated in the lithiation and delithiation and help to stabilize the integrity of the electrode. The amount of graphite increases in the order of SBG415>SBG433>SBG451. In view of the above, the combined effects of silicon layer thickness and the cushion effect of graphite can lead to the improved long-term stability of Si:B₄C:graphite materials having compositions close to that of SBG433. Similar principles can apply to optimization of other nancomposite compositions and structures of encompassed by embodiments of the present invention.

The first-cycle Coulombic efficiency increases in the order SBG415 (78.1%)<SBG433 (82.3%)<SBG451 (84.6%). The higher graphite content can lead to a larger surface area, which can result in more SEI film formation and a higher irreversible capacity. The BET results show the composites have surface areas that increase in the following order SBG415 (151.8 m² g⁻¹)>SBG433 (88.2 m² g⁻¹)>SBG451 (44.5 m² g⁻¹). Even the SBG415 still shows capacity retention of 88.0% after 75 cycles and a first-cycle efficiency of 78.1%.

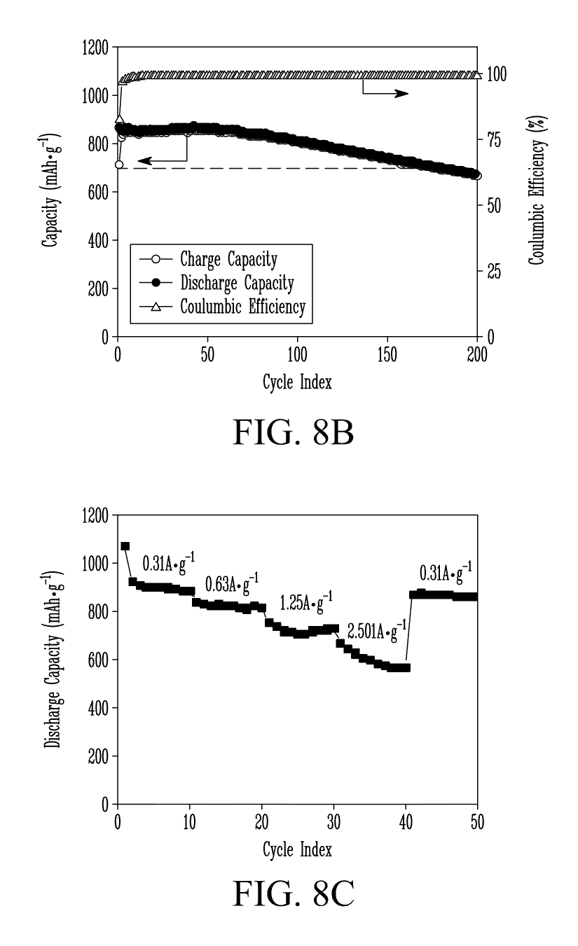

FIGS. 7b-c shows the effects of different ball-milling time on stability of SBG433 samples. The time for high energy ball-milling was varied from 4 hours, to 8 hours and to 12 hours, while the time for planetary ball-milling was fixed at 8 hours. As shown in FIG. 8b, the sample using 4-hour high-energy ball-milling shows relatively worse stability than the samples using 8-hour and 12-hour ball-milling. Its capacity retention after 30 cycles is 86.1% compared to approximately 100% for the sample using 8-hour high energy ball-milling and approximately 100% for the sample using 12-hour high energy ball-milling. The shorter high energy ball-milling time appeared to be less successful at breaking the micro-sized Si particles down to nano-size in which Si particles can tolerate the volume change generated during lithiation and delithiation. The samples using 8-hour and 12-hour high energy ball-milling have very similar capacity retention at approximately 100%.

FIG. 7c shows results obtained while the high energy ball-milling time was fixed at 8 hours and the planetary ball-milling time was changed from 4 hours, to 8 hours, to 12 hours. The capacity retention after 30 cycles is 90.9% for 4-hour sample, 100% for 8-hour sample and 93.1% for 12-hour sample. The shorter planetary ball-milling appears to be too short to establish higher graphite coverage on the B₄C/Si particles. Accordingly, for certain materials and in some embodiments, comminution occurs for at least 8 hours.

A SBG433 nanocomposite was prepared by 8-hour high-energy ball-milling followed by 8-hour planetary ball-milling. FIG. 8 includes discharge-charge profiles, long-term stability and rate performance data. The discharge capacity based on whole electrode weight is 868.8 mAh·g⁻¹ at the first cycle and 815.5 mAh·g⁻¹ at the 100^{th} cycle. The discharge capacity loss in the first 100 cycles is very small, only 0.06% per cycle. The charge capacity experiences an increase in the first 10 cycles due to the activation process. The capacity retention of SBG433 after 200 cycles is 78.5%. The Coulombic efficiency increases from 82.3% at the 1^{st} cycle to 97.8% at the 3^{rd} cycle, 99.0% at 10^{th} cycle and stayed above 99.0% afterwards (FIG. 9b). Owing to the good electrical conductivity of graphite and B₄C (140>S/m) in the composite, the SBG433 nanocomposite had exceptional rate performance as shown in FIG. 9c. The average remaining capacity was 900.1 mAh·g⁻¹ at 0.31 A·g⁻¹, 822.5 mAh·g⁻¹ at 0.63 A·g⁻¹, 723.6 mAh·g⁻¹ at 1.25 A·g⁻¹, and 601.2 mAh·g⁻¹ at 2.50 A·g⁻¹. The current densities are based on the weight of the silicon component but the capacity was based on the whole electrode weight including binder and conductive carbon. When the current density is changed from 2.50 A·g⁻¹ back to 0.31 A·g⁻¹, the discharge capacity is recovered and this excellent capacity recovery further verified the excellent rate performance of the Si:B₄C:graphite nanocomposites.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A functional nanocomposite material characterized by nanoparticles comprising an active material, a core particle comprising a comminution material, and a thin electronically conductive coating comprising an electronically conductive material, the nanoparticles fixed between the core particle and the conductive coating, wherein the comminution material has a Mohs hardness greater than that of the active material, the ratio between average diameters of the core particles and the nanoparticles is between 2 to 50.

2. The functional nanocomposite material of claim 1, wherein the functional nanocomposite material is arranged as an electrode, the core particle has a diameter less than 5000 nm, and the nanoparticles have diameters less than 500 nm.

3. The electrode of claim 2, wherein the active material comprises tin, tin oxide and combinations thereof.

4. The electrode of claim 3, having a reversible capacity of at least 400 mAh·g⁻¹ based on whole electrode weight over 100 cycles.

5. The electrode of claim 2, wherein the active material comprises silicon, silicon oxide and combinations thereof.

6. The electrode of claim 5, having a reversible capacity of at least 550 mAh·g⁻¹ based on the whole electrode weight over 100 cycles.

7. The electrode of claim 2, wherein the nanoparticles have a diameter less than or equal to 50 nm.

8. The electrode of claim 2, wherein the core particles have a diameter less than or equal to 1000 nm.

9. The electrode of claim 2, wherein the conductive material comprises a carbonaceous material.

10. The electrode of claim 9, wherein the carbonaceous material is selected from the group consisting of graphene, few-layer graphene, graphite, ketjenblack, carbon black, carbon fibers, carbon whiskers, soft carbon and combinations thereof.

11. The method of claim 2, wherein the conductive material comprises a conductive polymer.

12. The method of claim 2, wherein the conductive material comprises a powder having metal particles.

13. The electrode of claim 2, wherein the thin electronically conductive coating has a thickness less than 50 nm.

14. The electrode of claim 2, wherein the nanocomposite material comprises 10-90 wt % active material, 5-85 wt % comminution material, and 5-85 wt % conductive material.

15. The electrode of claim 2, wherein the nanocomposite material comprises active material, comminution material, and conductive material in a weight ratio from (18:1:1) to (2:17:1)/(2:1:17), respectively.

16. The electrode of claim 2, wherein the comminution material is electrically conductive and has a conductivity greater than 1 S/m.

17. The electrode of claim 2, wherein the comminution material is selected from the group consisting of boron carbide, tungsten carbide, titanium carbide, and silicon carbide and combinations thereof.

18. An electrode comprising a nanocomposite material, the nanocomposite material characterized by nanoparticles comprising an active material, a core particle comprising a comminution material having an electrical conductivity greater than 1 S/m, and a thin electronically conductive coating comprising a carbon material, the nanoparticles fixed between the core particle and the conductive coating, wherein the comminution material has a Mohs hardness greater than that of the active material, the core particle has a diameter less than 1000 nm, and the nanoparticles have diameters less than 200 nm, and wherein the electrode, when operated in a cell, has a capacity greater than 400 mAh·g⁻¹ based on whole electrode weight after 100 cycles.

19. A method of making a functional nanocomposite material, the method comprising: Comminuting a first mixture comprising an active material and a comminution material until particles of the active material are less than 500 nm in diameter and particles of the comminution material are less than 5000 nm in diameter, the comminution material having a Mohs hardness greater than the active material;
Fixing particles of the active material on the particles of the comminution material while performing said comminuting step, thereby yielding an intermediate nanocomposite; and
Mixing an amount of an electronically conductive material with the first mixture, thereby coating the intermediate nanocomposite with the electronically conductive material.

20. The method of claim 19, wherein the first mixture comprises 10-95 wt % active material.

21. The method of claim 19, wherein the first mixture comprises 5-90 wt % comminution material.

22. The method of claim 19, wherein the amount of the electronically conductive material is 5-85 wt % of the conductive material and first mixture total weight.

23. The method of claim 19, wherein said comminuting comprises ball-milling.

24. The method of claim 19, wherein said comminuting comprises comminuting until the particles of the active material are less than 200 nm in diameter and particles of the comminution material are less than 2000 nm in diameter.

25. The method of claim 19, wherein said comminuting comprises comminuting until the particles of the active material are less than 100 nm in diameter and particles of the comminution material are less than 1000 nm in diameter.

26. The method of claim 19, wherein the comminution material has an electrical conductivity greater than 1 S/m.

27. The method of claim 19, wherein the comminution material is selected from the group consisting of boron carbide, tungsten carbide, titanium carbide, and silicon carbide and combinations thereof.

28. The method of claim 19, wherein the active material is selected from the group consisting of silicon, silicon oxide, tin, tin oxide, and combinations thereof.

29. The method of claim 19, wherein the conductive material comprises a carbonaceous material.

30. The method of claim 29, wherein the carbonaceous material is selected from the group consisting of graphene, few-layer graphene, graphite, ketjenblack, carbon black, carbon fibers/whiskers, soft carbon and combinations thereof.

31. The method of claim 19, wherein the conductive material comprises a conductive polymer.

32. The method of claim 19, wherein the conductive material comprises a powder having metal particles.

33. An energy storage device having an anode comprising a nanocomposite material, a cathode, and a separator between the anode and the cathode, the nanocomposite material characterized by nanoparticles comprising an active material, a core particle comprising a comminution material, and a thin electronically conductive coating comprising an electronically conductive material, the nanoparticles fixed between the core particle and the conductive coating, wherein the comminution material has a Mohs hardness greater than that of the active material, the core particle has a diameter less than 5000 nm, and the nanoparticles have diameters less than 200 nm.

34. The energy storage device of claim 33, wherein the cathode comprises a material selected from the group consisting of lithium, lithium intercalation materials, lithium conversion compounds, and combinations thereof.
